(19) United States
(12) Patent Application Publication
(10) Pub. No.: US 2004/0245873 A1
(43) Pub. Date: Dec. 9, 2004

(54) Motor having magnetic oil seal structure

(75) Inventors: Lafite Lu, Taoyuan City (TW); Po Jen Shih, Taoyuan City (TW); Cheng Hsien Yeh, Taoyuan City (TW); Hsiang Ho Huang, Taoyuan City (TW)

Correspondence Address: BROWDY AND NEIMARK, P.L.L.C., 624 NINTH STREET, NW, SUITE 300, WASHINGTON, DC, 20001-5303, US

(73) Assignee: Ideal Elethermal Inc., Taoyuan City (TW)

(21) Appl. No.: 10/452,202

(22) Filed: Jun. 3, 2003

(51) Int. Cl. H02K 5/16; H02K 7/08

(52) U.S. Cl. 310/90

(57) ABSTRACT

A motor having a magnetic oil seal structure comprises a bearing sleeve, an oil-retaining bearing, a coil set, a rotor, a fastening ring, a magnet and magnetic fluid. The bearing sleeve has a receiving space. The oil-retaining bearing is received in the receiving space. The coil set is slipped outside the bearing sleeve. The rotor has an axis rotatably inserted into an axial hole of the oil-retaining bearing. The fastening ring is fastened on the axis and located above the oil-retaining bearing. The magnet is above the fastening ring. The magnetic fluid is provided between the magnet and the axis of the rotor. Magnetic force between the magnetic fluid and the magnet lets the magnetic fluid be tightly absorbed in the gap between the axis and the magnet to form a magnetic oil seal circuit, hence preventing the oil-retaining bearing from losing oil and greatly increasing its lifetime of use.

### FIELD OF THE INVENTION

The present invention relates to a motor having a magnetic oil seal structure and, more particularly, to a motor having a magnetic oil seal structure, which makes use of magnetic fluid to generate oil seal function so as to prevent an oil-retaining bearing from losing oil and to increase the lifetime of use of the oil-retaining bearing.

### BACKGROUND OF THE INVENTION

Along with quick development of the information industry, central processing units (CPUs) and electronic component operate at high speeds to generate a large amount of heat. Fans are required to radiate the heat for reducing the temperature. Therefore, the industry has increasing requirement for fan's motor.

After the axis of a conventional rotor passes through an oil-retaining bearing of a stator, in order to prevent the oil-retaining bearing from losing oil, an appropriate oil seal structure is generally provided. Conventionally, a fastening ring is fastened on the axis to form a simple oil seal structure. However, this method cannot effectively prevent the oil-retaining bearing from losing oil, hence greatly shortening the lifetime of use of the oil-retaining bearing.

Accordingly, the present invention aims to propose a motor having a magnetic oil seal structure to resolve the problems in the prior art.

### SUMMARY OF THE INVENTION

The primary object of the present invention is to provide a motor having a magnetic oil seal structure, which makes use of magnetic force generated by the interaction between magnetic fluid and a magnet to tightly absorb the magnetic fluid in the gap between the axis and the magnet for forming a second oil seal circuit so as to completely seal and form an oil supply circuit. The oil-retaining bearing can thus be prevented from losing oil, hence greatly increasing the lifetime of use of the oil-retaining bearing.

To achieve the above object, the present invention provides a motor having a magnetic oil seal structure, which comprises a bearing sleeve, an oil-retaining bearing, a coil set, a rotor, a fastening ring, a magnet and magnetic fluid. The bearing sleeve has a receiving space therein. The oil-retaining bearing is received in the receiving space of the bearing sleeve, and has an axial hole. The coil set is slipped outside the bearing sleeve. The rotor has an axis, which is rotatably inserted into the axial hole of the oil-retaining bearing. The fastening ring is fastened on the axis, and is located above the oil-retaining bearing. The magnet is disposed above the fastening ring. The magnetic fluid is provided between the magnet and the axis of the rotor. Magnetic force generated by the interaction between the magnetic fluid and the magnet tightly absorbs the magnetic fluid in the gap between the axis and the magnet, thereby forming a magnetic oil seal circuit.

The various objects and advantages of the present invention will be more readily understood from the following detailed description when read in conjunction with the appended drawing, in which:

### BRIEF DESCRIPTION OF THE DRAWINGS

FIG. 1 is an exploded perspective view of the present invention;

FIG. 2 is a perspective assembly view of the present invention; and

FIG. 3 is a cross-sectional view of the present invention.

### DETAILED DESCRIPTION OF THE PREFERRED EMBODIMENTS

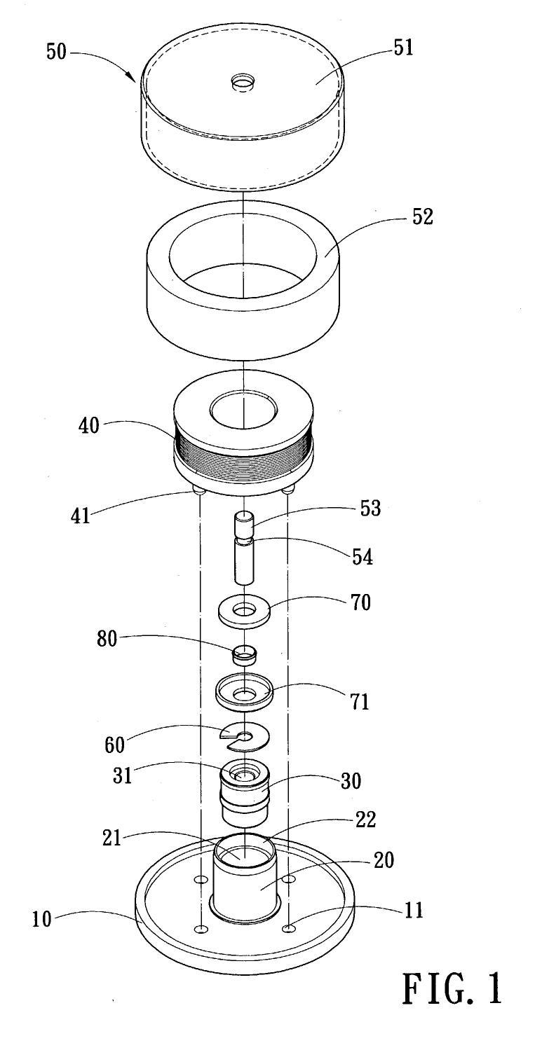

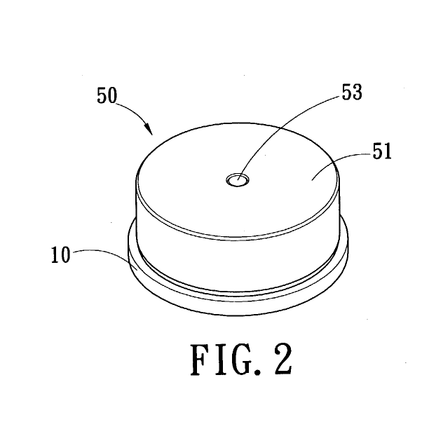

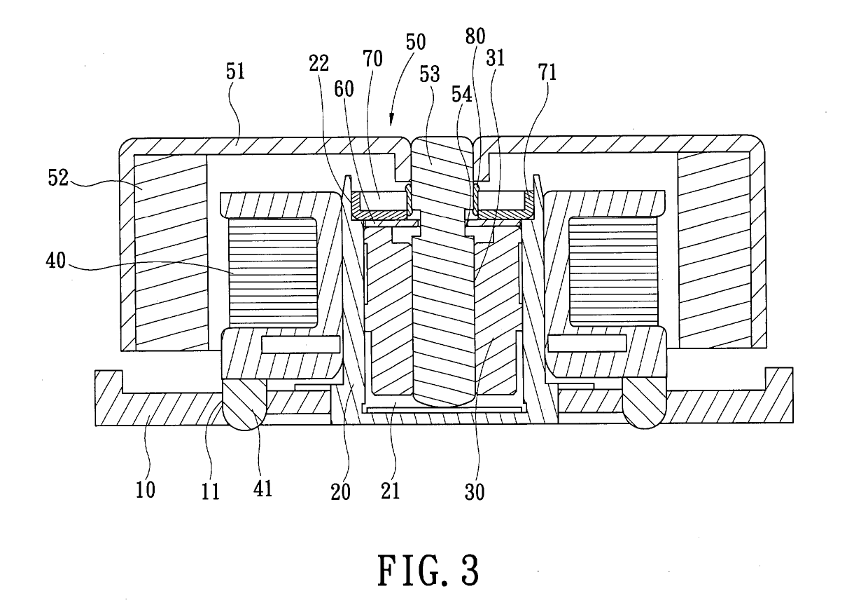

As shown in FIGS. 1 to 3, the present invention provides a motor having a magnetic oil seal structure, which comprises a base 10, a bearing sleeve 20, an oil-retaining bearing 30, a coil set 40, a rotor 50, a fastening ring 60, a magnet 70 and magnetic fluid 80. The base 10 is a plate with a circuit board (not shown) provided thereon for controlling the operation of the coil set 40. The base 10 can be used to fix the bearing sleeve 20 and the coil set 40.

The bearing sleeve 20 is properly fixed on the base 10. The bearing sleeve 20 is a hollow cylinder, i.e., it has a receiving space 21 and a fixing groove 22 therein. The bottom and side face of the receiving space 21 are close, and the top thereof is open. The fixing groove is disposed above the receiving space 21, and is connected with the receiving space 21. The top and side face of the fixing groove 22 are open.

The oil-retaining bearing 30 is received in the receiving space 21 of the bearing sleeve 20. The oil-retaining bearing 30 is fixedly disposed in the receiving space 21 in tight match way. The oil-retaining bearing 30 has an axial hole 31 at the center thereof. The axial hole 31 passes through the top and bottom of the oil-retaining bearing 30, and can be used to assemble an axis 53 of the rotor 50.

The coil set 40 is slipped outside the bearing sleeve 20. The coil set 40 has a positioning pole 41 at the bottom thereof. A corresponding positioning hole 11 is disposed on the base 10. The positioning pole 41 is inserted and fixed in the positioning hole 11 so that the coil set 40 can be fixed on the base 10.

The rotor 50 has a shell body 51, a permanent magnet 52 and an axis 53. The shell body 51 is a hollow shell body with an open bottom. The permanent magnet 52 is fixed in the shell body 51. The axis 53 is fixedly connected at the center of the shell body 51. A groove 54 is annularly disposed near the top of the axis 53. The axis 53 of the rotor 50 is rotatably inserted into the axial hole 31 of the oil-retaining bearing 30. The shell body 51 covers outside the bearing sleeve 20 and the coil set 40. The inner edge of the permanent magnet 52 corresponds to the outer edge of the coil set 40 with a certain air gap kept between them.

The fastening ring 60 is fastened on groove 54 of the axis 53, and is located above the oil-retaining bearing 30. The fastening ring 60 can roughly shield the top of the receiving space 21 to form a first simple oil seal structure between the fastening ring 60, the oil-retaining bearing 30 and the axis 53.

The magnet 70 is circular ring-shaped, and is disposed above the fastening ring 60. In this embodiment, the magnet 70 is disposed in the fixing groove 22 of the bearing sleeve 20. The magnet 70 is first fixed in a magnetic conduction cover 71, and the magnetic conduction cover 71 is then fixed in the fixing groove 22 of the bearing sleeve 20 in tight match way. In addition to having the function of fixing the magnet 70, the magnetic conduction cover 71 has also shielding effect to prevent magnetic interference.

The magnetic fluid 80 is made of magnetic conduction material, and is semisolid. The magnetic fluid 80 is circular ring-shaped, and is provided between the magnet 70 and the axis 53 of the rotor 50. The magnetic fluid 80 is adjacent to the magnet 70 so that a magnetic field can be generated between the magnetic fluid 80 and the magnet 70. Magnetic force generated by the interaction between the magnetic fluid 80 and the magnet 70 lets the magnetic fluid 80 be tightly absorbed in the gap between the axis 53, the magnetic conduction cover 71 and the magnet 70, thereby forming a magnetic (second) oil seal circuit. A motor having a magnetic oil seal structure of the present invention is thus formed.

To sum up, the present invention is characterized in that a magnetic oil seal structure is provided. In addition to utilizing the fastening ring 60, the oil-retaining bearing 30 and the axis 53 to form the first simple oil seal structure, the motor of the present invention also makes use of the magnetic force generated by the interaction between the magnetic fluid 80 and the magnet 70 to tightly absorb the magnetic fluid 80 in the gap between the axis 53, the magnetic conduction cover 71 and the magnet 70, thereby forming the magnetic (second) oil seal circuit. Therefore, the present invention can accomplish more complete seal to form an oil supply circuit as compared to a conventional oil seal structure. Moreover, the oil-retaining bearing 30 can be prevented from losing oil, hence greatly increasing the lifetime of use of the oil-retaining bearing 30.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A motor having a magnetic oil seal structure, comprising:
a bearing sleeve having a receiving space therein;
an oil-retaining bearing received in said receiving space of said bearing sleeve, said oil-retaining bearing having an axial hole;
a coil set slipped outside said bearing sleeve;
a rotor having an axis, said axis being rotatably inserted into said axial hole of said oil-retaining bearing;
a fastening ring fastened on said axis and located above said oil-retaining bearing;
a magnet disposed above said fastening ring; and
magnetic fluid disposed between said magnet and said axis of said rotor, magnetic force generated by the interaction between said magnetic fluid and said magnet tightly absorbing said magnetic fluid in a gap between said axis and said magnet to form a magnetic oil seal circuit

2. The motor having a magnetic oil seal structure as claimed in claim 1, wherein said bearing sleeve further has a fixing groove therein, said fixing groove is disposed above said receiving space, a magnetic conduction cover is fixed in said fixing groove, and said magnet is fixed in said magnetic conduction cover.

3. The motor having a magnetic oil seal structure as claimed in claim 1, wherein a base is further provided below said coil set, said coil set has a positioning pole at the bottom thereof, a corresponding positioning hole is provided on said base, and said positioning pole is inserted and fixed in said positioning hole to fix said coil set on said base.

4. The motor having a magnetic oil seal structure as claimed in claim 1, wherein a groove is annularly disposed on said axis, and said fastening ring is fastened on said groove of said axis.

5. The motor having a magnetic oil seal structure as claimed in claim 1, wherein said rotor has also a shell body and a permanent magnet, said permanent magnet is fixedly disposed in said shell body, said axis is fixedly connected at the center of said shell body, said shell body covers outside said bearing sleeve and said coil set, and an inner edge of said permanent magnet corresponds to an outer edge of said coil set with a certain air gap kept in between.

6. The motor having a magnetic oil seal structure as claimed in claim 1, wherein said magnetic fluid is made of magnetic conduction material, and is semisolid.
